(19) United States
(12) Patent Application Publication
(10) Pub. No.: US 2012/0178607 A1
(43) Pub. Date: Jul. 12, 2012

(54) Paper Folding Device

(75) Inventor: Isao Yasuda, Aichi (JP)

(73) Assignee: RICOH COMPANY, LIMITED, Tokyo (JP)

(21) Appl. No.: 13/342,281

(22) Filed: Jan. 3, 2012

(30) Foreign Application Priority Data
Jan. 7, 2011 (JP) 2011-002514

(51) Int. Cl. B31F 1/10

(52) U.S. Cl. 493/442

(57) ABSTRACT

According to an embodiment, there is provided a paper folding device that folds paper by nipping the paper between a pair of folding rollers each of which rollers is rotatably supported. The paper folding device includes: a shaft-to-shaft distance adjusting unit that adjusts a shaft-to-shaft distance between the two folding rollers so that a predetermined pressure is applied to the paper nipped between the pair of folding rollers; and a fixing unit that fixes the pair of folding rollers at a position where the folding rollers are at the shaft-to-shaft distance adjusted by the shaft-to-shaft distance adjusting unit.

### CROSS-REFERENCE TO RELATED APPLICATIONS

The present application claims priority to and incorporates by reference the entire contents of Japanese Patent Application No. 2011-002514 filed in Japan on Jan, 7, 2011.

### BACKGROUND OF THE INVENTION

1. Field of the Invention

The present invention relates to a paper folding device that performs a folding process on paper.

2. Description of the Related Art

Hitherto, there is a known paper folding device which performs a folding process in which a crease is made on paper while stopping the front end of the paper which is being conveyed so that the paper is bent, the paper with the bent portion is conveyed, and the bent portion is nipped between a pair of folding rollers.

In a paper folding device disclosed in Japanese Patent No. 4307460, a movable folding roller which is one folding roller of a pair of folding rollers is configured to be tiltable with respect to a fixed folding roller which is the other folding roller and of which the position is fixed so that the movable roller is pushed back by paper which advances into a gap between the rollers, the pair of folding rollers, and thus the gap between the rollers changes depending on the thickness of the paper. Further, the movable folding roller is biased by a spring toward the fixed folding roller, and the bent portion of the paper nipped between the pair of folding rollers is crushed to be folded by the pressure applied from the movable folding roller biased by the spring.

However, when the position of the movable folding roller biased by the spring is changed due to an impact generated when the paper advances into the gap between the pair of folding rollers, the shaft-to-shaft distance between the pair of folding rollers increases, so that a force for crushing the bent portion of the paper by the pair of folding rollers is instantaneously weakened. When the crushing force is too weak, a problem arises in that the paper may not be strongly folded by the pair of folding rollers.

### SUMMARY OF THE INVENTION

According to an embodiment, there is provided a paper folding device that folds paper by nipping the paper between a pair of folding rollers each of which rollers is rotatably supported. The paper folding device includes: a shaft-to-shaft distance adjusting unit that adjusts a shaft-to-shaft distance between the two folding rollers so that a predetermined pressure is applied to the paper nipped between the pair of folding rollers; and a fixing unit that fixes the pair of folding rollers at a position where the folding rollers are at the shaft-to-shaft distance adjusted by the shaft-to-shaft distance adjusting unit.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a schematic diagram illustrating a pair of folding rollers which includes a first folding roller and a second folding roller, seen from upside and from axial direction;

FIG. 2 is a schematic configuration diagram illustrating a paper folding device according to the embodiment;

FIG. 3 is a diagram which is used to describe Z-fold;

FIG. 4 is a diagram which is used to describe inward tri-fold;

FIG. 5 is a schematic diagram illustrating the first folding roller and the second folding roller which are seen from the axial direction;

FIG. 6 is a radial cross-sectional view illustrating a folding roller which is made by forming an elastic body on metal serving as a core;

FIG. 7 is a radial cross-sectional view illustrating a folding roller which is made by forming an elastic body with a double-layered structure in which rigid rubber and soft rubber overlap each other on metal serving as a core;

FIG. 8 is a radial cross-sectional view illustrating a folding roller made of metal; and

FIG. 9 is a radial cross-sectional view illustrating a folding roller made by coating process on the surface of metal.

### DETAILED DESCRIPTION OF THE PREFERRED EMBODIMENTS

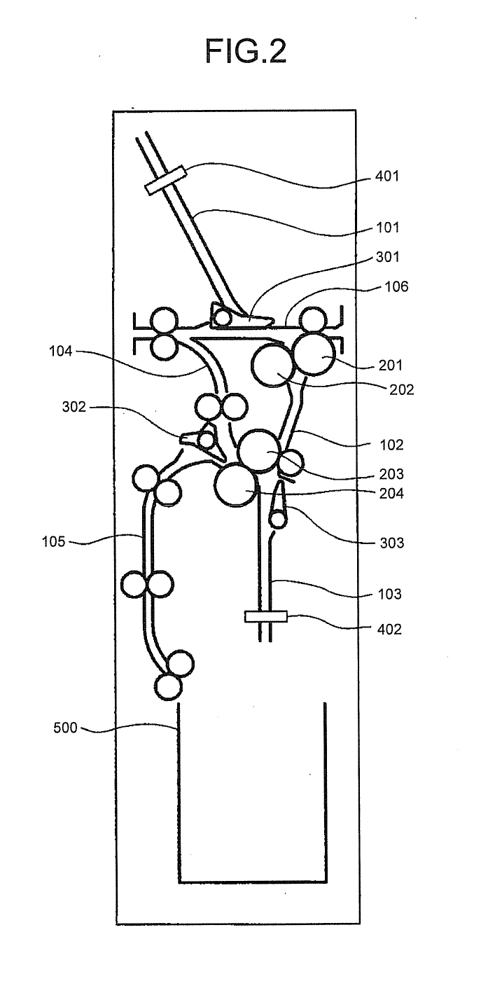

FIG. 2 is a schematic configuration diagram illustrating a paper folding device according to an embodiment.

The paper folding device includes a conveying path which is used to convey paper. The conveying path includes a first stopper conveying path 101, a second conveying path 102, a second stopper conveying path 103, a fourth conveying path 104, a fifth conveying path 105, and a straight conveying path 106. Furthermore, the straight conveying path 106 is a conveying path which receives paper from a paper receiving opening and conveys the paper to a post-processing device disposed at the downstream side in the paper conveying direction in relation to the paper folding device without folding the paper. The respective conveying paths are formed in a manner such that guide plates used for guiding a paper conveying operation are provided at both sides in the paper thickness direction with a predetermined gap (distance) therebetween. With regard to the respective conveying paths, the conveying paths are directly connected to each other or are arranged with a pair of rollers including two folding rollers interposed therebetween. Further, a first switching claw 301, a second switching claw 302, and an inward tri-turn preventing claw 303 which guide the paper to the respective conveying paths are provided so as to switch the conveying path. Further, a first stopper 401 and a second stopper 402, which serve as stopper members bringing the front end of the conveyed paper into contact with thereto, are respectively provided inside the conveying paths, the first stopper conveying path 101 and the second stopper conveying path 103. Further, a first folding roller 201 and a second folding roller 202 constitute a pair of folding rollers, and a third folding roller 203 and a fourth folding roller 204 constitute a pair of folding rollers.

With such a configuration, a paper folding process for each folding mode (Z-fold, outward tri-fold, and inward tri-fold) can be performed. Hereinafter, the respective folding processes will be described.

Z-Fold

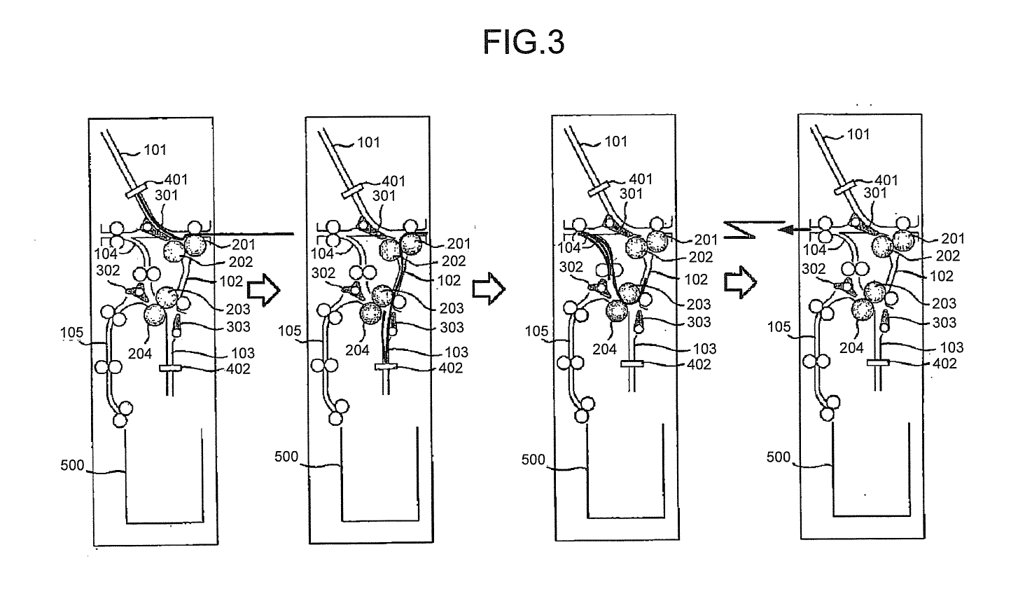

As illustrated in FIG. 3, the paper which is received from a main body is guided by the first switching claw 301 to the first stopper conveying path 101. The front end of the paper bumps into the first stopper 401 inside the first stopper conveying path 101 so that the paper is bent; and the paper is folded at the nip between the first folding roller 201 and the second folding roller 202, thereby performing a first folding process on the paper. After the first folding process is completed, the paper is conveyed from the second conveying path 102 to the second stopper conveying path 103; the front end of the paper is bent by the second stopper 402 inside the second stopper conveying path 103; and the paper is folded at the nip between the third folding roller 203 and the fourth folding roller 204, thereby performing a second folding process on the paper. In this way, the Z-fold is completed. After the Z-fold is completed, the paper is guided by the second switching claw 302 to the fourth conveying path 104, and is conveyed to a downstream machine.

Inward Tri-Fold

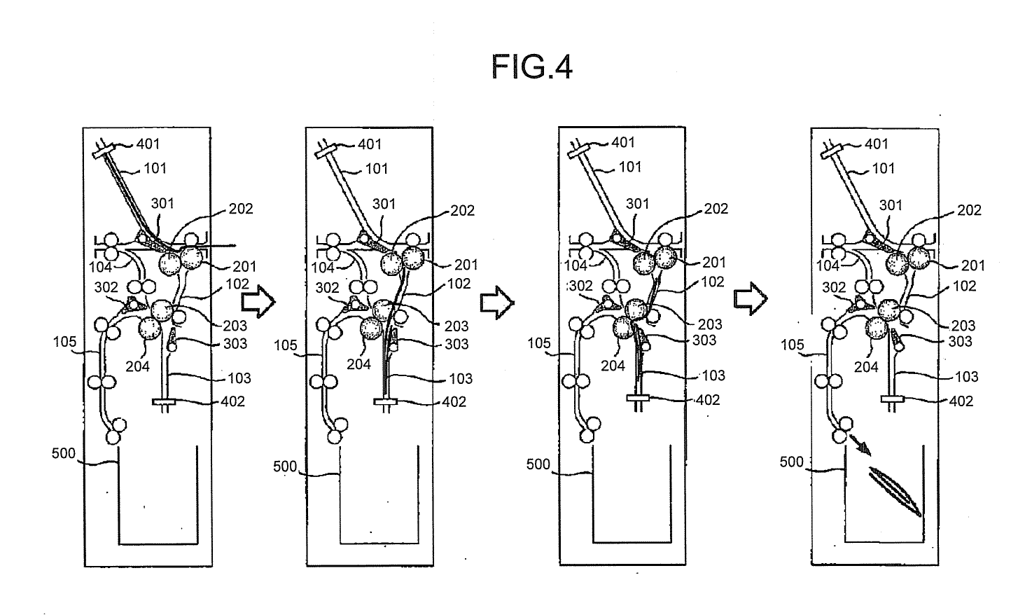

As illustrated in FIG. 4, the paper which is received from the main body is guided by the first switching claw 301 to the first stopper conveying path 101. The front end of the paper bumps into the first stopper 401 inside the first stopper conveying path 101, and the paper is folded at a first nip between the first folding roller 201 and the second folding roller 202, thereby performing a first folding process on the paper. After the first folding process is completed, the paper is conveyed from the second conveying path 102 to the second stopper conveying path 103, the front end of the paper bumps into the second stopper 402 inside the second stopper conveying path 103 so that the paper is bent, and the paper is folded at a second nip between the third folding roller 203 and the fourth folding roller 204, thereby performing a second folding process on the paper. At this time, the paper which is folded inward by the inward tri-turn preventing claw 303 is folded at a second nip while the front end of the paper is guided to the second nip. In this way, the inward tri-fold is completed. After the inward tri-fold is completed, the paper is conveyed by the second switching claw 302 to the fifth conveying path 105 and is conveyed to a stacker 500 inside the device.

Outward Tri-Fold

The paper which is received from the main body is guided by the first switching claw 301 to the first stopper conveying path 101. The front end of the paper bumps into the first stopper 401 inside the first stopper conveying path 101 so that the paper is bent, and the paper is folded at a first nip between the first folding roller 201 and the second folding roller 202, thereby performing a first folding process. After the first folding process is completed, the paper is conveyed from the second conveying path 102 to the second stopper conveying path 103, the front end of the paper bumps into the second stopper 402 inside the second stopper conveying path 103 so that the paper is bent, and then the paper is folded at a second nip between the third folding roller 203 and the fourth folding roller 204, thereby performing a second folding process. In this way, the outward tri-fold is completed. After the outward tri-fold is completed, the paper is guided by the second switching claw 302 to the fifth conveying path 105 and is conveyed to a stacker 500 inside the device.

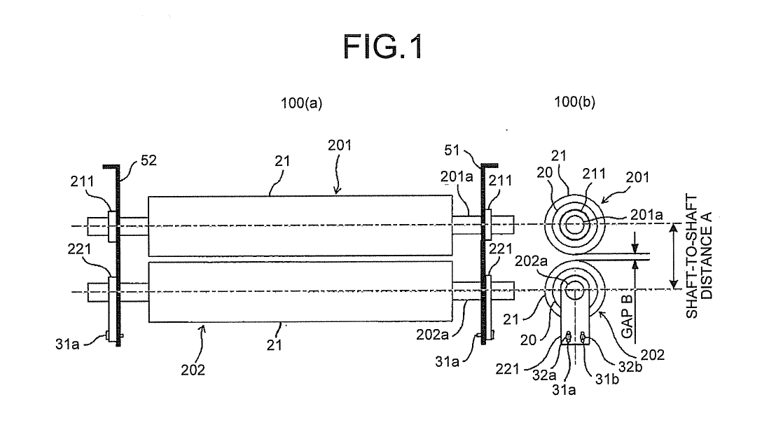

FIG. 1 is a schematic diagram when a pair of folding rollers including the first folding roller 201 and the second folding roller 202 is seen from the upside shown by numeral 100(a); and is a schematic diagram when the first folding roller 201 and the second folding roller 202 are seen from the axial direction shown by numeral 100(b). As shown by the numeral 100(b), a front side plate 51 or a rear side plate 52 are not illustrated in the drawing so that the paper folding device is easily understood.

At least one of the first folding roller 201 and the second folding roller 202 is rotationally driven by a driving source including a motor (not illustrated). Furthermore, in the case of the configuration in which only one of the first folding roller 201 and the second folding roller 202 is rotationally driven by the driving source, when the paper is nipped between the first folding roller 201 and the second folding roller 202, the rotational driving force is transmitted from one folding roller which is rotationally driven by the driving source to the other folding roller through the paper, so that the other folding roller rotates.

As illustrated by the numeral 100(b) in FIG. 1, the first folding roller 201 and the second folding roller 202 are provided at the front side plate 51 and the rear side plate 52 through bearings 211 and 212, each of which bearings respectively support a shaft 201a of the first folding roller 201 and a shaft 202a of the second folding roller 202 so that the shafts are rotatable, at a position where a gap between shaft centers of both rollers becomes a shaft-to-shaft distance A and a gap between the opposite roller surfaces of the first folding roller 201 and the second folding roller 202 becomes a gap B. The shaft-to-shaft distance A is designed so that a strong folding process may be performed on the paper by a predetermined pressure applied thereto when the paper is nipped between the first folding roller 201 and the second folding roller 202.

Further, the shaft-to-shaft distance A or the gap B may be adjusted by changing the position of the second folding roller 202 with respect to the first folding roller 201 in a manner such that a bearing 221 is displaced with respect to the front side plate 51 or the rear side plate 52 by a elongated holes 31a and 31b formed in the bearing 221 and a fixing screws 32a and 32b.

In the related art, the folding roller is pressed by a spring or the like, and a folding portion of the paper nipped between the pair of folding rollers is crushed by the pressure of the spring, so that the folding process is performed on the paper. However, when the folding portion of the paper passes through the nip between the folding rollers, the folding rollers pressed by the springs are struck up in the direction in which the nip between the folding rollers are opened due to the power generated at the moment when the folding portion of the paper passes between the pair of folding rollers. Accordingly, since the gap between the pair of folding rollers is pulled and separated by the extent corresponding to the paper thickness or more (the extent corresponding to the paper thickness or more of two sheets of paper in the case of the first folding process), a problem arises in that the folding portion of the paper may not be strongly folded.

In order to prevent such a phenomenon in which the folding roller is struck up, a method may be considered in which the pressure applied from the springs to the folding roller becomes stronger. However, in the configuration in which the pressure is applied from the springs to both ends of the folding roller, an even pressure may not be applied to the folding roller due to the bending generated in the folding roller. Also, when a fairly strong pressure is not applied to the folding roller, the occurrence of the above-described striking-up phenomenon may not be suppressed. For this reason, the folding portion of the paper may not be strongly folded only by an increase in pressure of the spring pressing the folding roller, which may not expect a large effect as a countermeasure for a decrease in folding height.

On the other hand, in the embodiment, since the positions of the first folding roller 201 and the second folding roller 202 of the pair of folding rollers are fixed at the shaft-to-shaft distance A where a predetermined pressure is applied to the paper nipped between the pair of folding rollers, the paper may be folded by the predetermined pressure applied from the pair of folding rollers without a phenomenon in which the position of the first folding roller 201 or the second folding roller 202 changes due to the impact generated when the paper advances between the pair of folding rollers and the shaft-to-shaft distance between the pair of folding rollers increases. Thus, compared to a case where the position of the folding roller changes due to the impact generated when the paper advances between the pair of folding rollers, the paper may be strongly folded by the pair of folding rollers and the folding height of the paper may be decreased.

Further, since there is no need to provide a mechanism for pressing a folding roller using a spring as in the related art, a paper folding device which is simple, small, and cheap may be provided.

Further, in addition to the configuration in which the positions of the first folding roller 201 and the second folding roller 202 are fixed by adjusting the shaft-to-shaft distance A therebetween, it is desirable to fix the first folding roller 201 and the second folding roller 202 at a position where the gap between the opposite roller surfaces of the first folding roller 201 and the second folding roller 202 is not equal to 0 mm, that is, a gap is formed between the opposite roller surfaces. In this way, when a gap is formed between the opposite roller surfaces of the first folding roller 201 and the second folding roller 202, wrinkles may be suppressed from being generated in the paper. Further, the folding height may be highly effectively decreased when the gap between the opposite roller surfaces of the first folding roller 201 and the second folding roller 202 is set to 0.3 mm or less.

On the other hand, the gap B as a gap between the opposite roller surfaces of the first folding roller 201 and the second folding roller 202 is adjusted depending on, for example, the thickness of the paper which is folded by being nipped between the first folding roller 201 and the second folding roller 202.

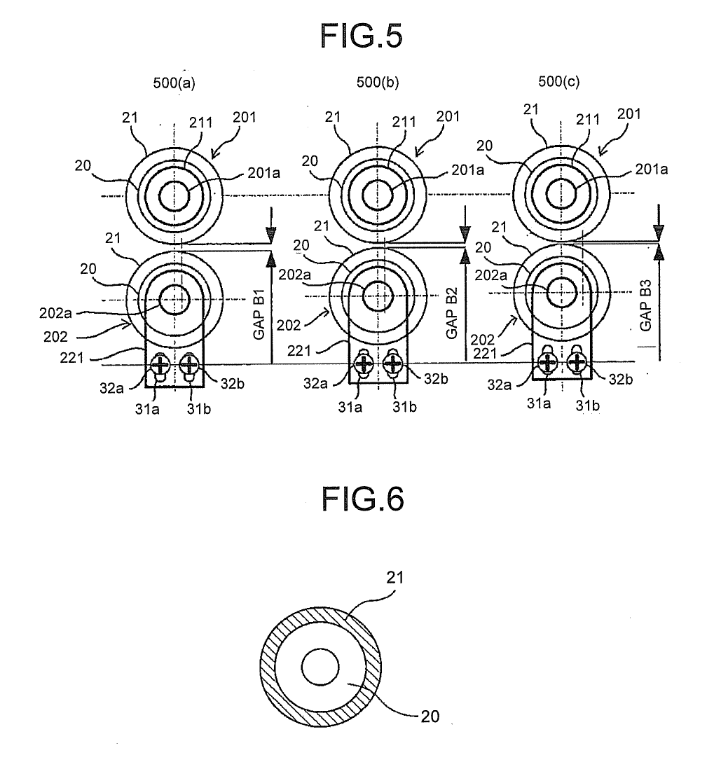

The numeral 500(a) in FIG. 5 illustrates a case where the second folding roller 202 is fixed with a gap B1 as a gap between the roller surfaces when cardboard thickener than normal paper is used. The numeral 500(b) in FIG. 5 illustrates a case where the second folding roller 202 is fixed with a gap B2 as a gap between the roller surfaces when normal paper is used. The numeral 500(c) in FIG. 5 illustrates a case where the second folding roller 202 is fixed with a gap B3 as a gap between the roller surfaces when thin paper thinner than normal paper is used. Here, there is a relation of gap B1 (for cardboard)>gap B2 (for normal paper)>gap B3 (for thin paper) between the gap B1 for the cardboard, the gap B2 for the normal paper, and the gap B3 for the thin paper.

In this way, since the folding height may be decreased and the load applied to a driving source such as a motor may be reduced by adjusting the gap between the opposite roller surfaces of the first folding roller 201 and the second folding roller 202 depending on the thickness of the paper which is folded by being nipped between the first folding roller 201 and the second folding roller 202, thus energy may be effectively saved.

Further, the gap B between the opposite roller surfaces of the first folding roller 201 and the second folding roller 202 may be adjusted depending on the number of the folding processes performed on the paper which is folded by being nipped between the first folding roller 201 and the second folding roller 202. Then, when the gap between the roller surfaces of the first folding roller 201 and the second folding roller 202 used for the first folding process is set to a gap B4 and the gap between the roller surfaces of the first folding roller 201 and the second folding roller 202 used for the second folding process is set to a gap B5, there is a relation of gap B5 (for second folding process)>gap B4 (for first folding process).

In this way, since the folding height may be decreased and the load applied to a driving source such as a motor may be reduced by adjusting the gap between the opposite roller surfaces of the first folding roller 201 and the second folding roller 202 depending on the thickness of the paper which is folded by being nipped between the first folding roller 201 and the second folding roller 202, thus energy may be effectively saved.

As illustrated in FIG. 6, the folding roller has a configuration in which a rubber 21 is formed as an elastic body on a metal 20 serving as a core. The hardness of the rubber 21 used as the elastic body is desirably from 60 to 100 degree based on JIS-A hardness, and the thickness of the rubber 21 is desirably from 1 mm to 5 mm. Accordingly, the paper may be strongly folded by the pair of folding rollers. Then, since the rubber 21 is elastically deformed when the paper is nipped between the pair of folding rollers, the load applied to a driving source such as a motor may be reduced, energy may be effectively saved.

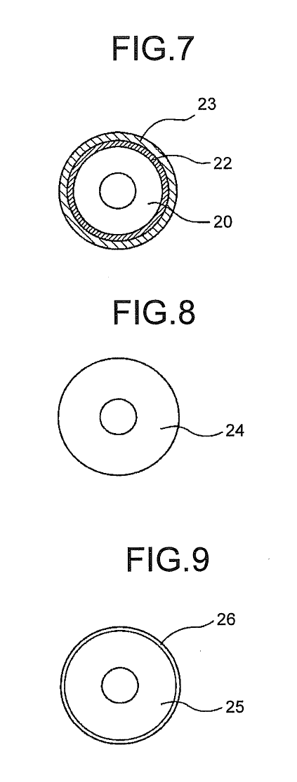

Further, the configuration of the elastic body is not limited to a single material, and as illustrated in FIG. 7, a structure may be adopted which has a double-layered structure obtained by an overlapping hard rubber 22 and a soft rubber 23 on the metal 20. In a case where the elastic body has a double-layered structure obtained by overlapping the hard rubber 22 and the soft rubber 23, as illustrated in FIG. 7, a structure may be adopted in which the outside rubber is softer than the inside rubber and the soft rubber 23 is laminated on the hard rubber 22.

On the other hand, as illustrated in FIG. 8, the folding roller may be formed only by a metal 24 without forming an elastic body such as rubber on the metal 24 as a core. When the folding roller is formed only by the metal 24, a strong folding process may be performed and the folding height may be further decreased compared to a case where an elastic body such as rubber is formed on the surface of the metal 24. Further, since the friction coefficient of the surface of the folding roller against the paper is low compared to a case where an elastic body such as rubber is formed on the metal 24, stress applied to the paper which passes between the pair of folding rollers is small, and hence wrinkles may be suppressed from being generated in the paper.

Further, as illustrated in FIG. 9, a coating process may be performed in which a material with a friction coefficient against the paper larger than the friction coefficient of the surface of a metal 25 forms a coating layer 26 on the surface of the metal 25.

In a case where the folding roller is formed only by the metal 25, there is a concern that the paper may slip on the folding roller and the paper may not enter between the pair of folding rollers due to the low friction coefficient of the surface of the roller against the paper. For this reason, when the coating layer 26 is formed by coating a resin or the like on the metal 25, the friction coefficient of the surface of the folding roller against the paper increases. Accordingly, a strong folding process may be performed while suppressing the generation of the slip of the paper on the folding roller and the folding height may be further decreased compared to a case where an elastic body such as rubber is formed on the metal 25.

As described above, according to the embodiment, in the paper folding device which folds paper by nipping it between a pair of folding rollers which respectively serves as the first folding roller 201 and the second folding roller 202 as two rotatably supported folding rollers, the paper folding device includes: the shaft-to-shaft distance adjusting unit which is formed by the bearing 221 or the elongated holes 31a and 31b and adjusts the shaft-to-shaft distance between the first folding roller 201 and the second folding roller 202, so that a predetermined pressure is applied to the paper nipped between the pair of folding rollers; and the fixing unit which is formed by the fixing screws 32a and 32b and fixes the positions of the pair of folding rollers at the shaft-to-shaft distance adjusted by the shaft-to-shaft distance adjusting unit. Here, the shaft-to-shaft distance between the pair of folding rollers may be adjusted by the shaft-to-shaft distance adjusting unit so that a predetermined pressure is applied to the paper nipped between the pair of folding rollers, and the positions of the pair of folding rollers may be fixed at the adjusted shaft-to-shaft distance by the fixing screws 32a and 32b. Accordingly, the paper may be folded with a predetermined pressure applied by the pair of folding rollers without causing a phenomenon in which the position of the first folding roller 201 or the second folding roller 202 changes and the shaft-to-shaft distance between the pair of folding rollers increases due to an impact generated when the paper advances between the pair of folding rollers. Thus, compared to a case where the positions of the folding rollers change due to the impact generated when the paper advances between the pair of folding rollers, a strong folding process may be performed on the paper by the pair of folding rollers.

Furthermore, according to the embodiment, since a gap is formed between the pair of folding rollers, occurrence of paper wrinkled may be avoided.

Furthermore, according to the embodiment, since the shaft-to-shaft distance is adjustable by the shaft-to-shaft distance adjusting unit depending on the thickness of the paper which is folded by the pair of folding rollers, the load of a driving source such as a motor rotationally driving at least one of the first folding roller 201 and the second folding roller 202 may be reduced; and thus energy may be effectively saved.

Furthermore, according to the embodiment, since the shaft-to-shaft distance is adjustable by the shaft-to-shaft distance adjusting unit depending on the number of the folding processes performed on the paper which is folded by the pair of folding rollers, the load applied to a driving source such as a motor rotationally driving at least one of the first folding roller 201 and the second folding roller 202 may be reduced, and thus energy may be effectively saved.

Further, according to the embodiment, the first folding roller 201 or the second folding roller 202 is includes the rubber 21 on the surface of the metal 20 as a cylindrical core, and the hardness of the rubber 21 is from 60 to 100 degree based on the JIS-A hardness. Accordingly, a strong folding process may be performed on the paper. Then, the rubber 21 is elastically deformed when the paper is nipped between the pair of folding rollers, and hence the load, applied to a driving source such as a motor rotationally driving at least one of the first folding roller 201 and the second folding roller 202, may be reduced. Accordingly, thus energy may be effectively saved.

Further, according to the embodiment, the first folding roller 201 or the second folding roller 202 includes the rubber 21 on the surface of the metal 20 as a cylindrical core, and the thickness of the rubber 21 is from 1 mm to 5 mm. Accordingly, a strong folding process may be performed on the paper. Then, the rubber 21 is elastically deformed when the paper approaches the pair of folding rollers, and hence the load applied to a driving source such as a motor rotationally driving at least one of the first folding roller 201 and the second folding roller 202 may be reduced. Accordingly, thus energy may be effectively saved.

Further, according to the embodiment, since at least one folding roller of the pair of folding rollers is formed by the cylindrical metal 24, a strong folding process may be performed and the folding height may be further decreased compared to a case where an elastic body such as rubber is formed on metal. Further, since the friction coefficient of the surface of the folding roller against the paper is low compared to a case where an elastic body such as rubber is formed on metal, the stress applied to the paper passing between the pair of folding rollers is small, and hence occurrence of paper wrinkled may be avoided.

Further, according to the embodiment, since a coating process is performed in a manner such that a resin as a material with a friction coefficient against the paper larger than the friction coefficient of the surface of the metal 25 is coated on the surface of the cylindrical metal 25 so as to form a coating layer 26 thereon, the friction coefficient of the surface of the folding roller against the paper increases. Accordingly, a strong folding process may be performed while suppressing the generation of the slip of the paper on the folding roller and the folding height may be further decreased compared to a case where an elastic body such as rubber is formed on the metal.

In the embodiment, the shaft-to-shaft distance between the pair of folding rollers is adjusted by the shaft-to-shaft distance adjusting unit so that a predetermined pressure is applied to the paper nipped between the pair of folding rollers; and the pair of folding rollers are fixed by the fixing unit at the positions where they are at the adjusted shaft-to-shaft distance. With the configuration, the paper may be folded with a predetermined pressure applied by the pair of folding rollers, because the position of the folding roller does not change and thus the shaft-to-shaft distance between the pair of folding rollers does not increase when there is the impact generated when the paper advances into the gap between the pair of folding rollers. Thus, compared with a case where the positions of the folding rollers change due to the impact generated when the paper advances into the gap between the pair of folding rollers, the paper can be strongly folded by the pair of folding rollers.

As described above, according to the embodiment, a strong folding process may be performed on paper by the pair of folding rollers.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A paper folding device that folds paper by nipping the paper between a pair of folding rollers each of which rollers is rotatably supported, the paper folding device comprising:
a shaft-to-shaft distance adjusting unit that adjusts a shaft-to-shaft distance between the two folding rollers so that a predetermined pressure is applied to the paper nipped between the pair of folding rollers; and
a fixing unit that fixes the pair of folding rollers at a position where the folding rollers are at the shaft-to-shaft distance adjusted by the shaft-to-shaft distance adjusting unit.

2. The paper folding device according to claim 1,
wherein a gap is formed between the pair of folding rollers.

3. The paper folding device according to claim 1,
wherein the shaft-to-shaft distance is adjustable by the shaft-to-shaft distance adjusting unit depending on a thickness of the paper which is folded by the pair of folding rollers.

4. The paper folding device according to claim 1,
wherein the shaft-to-shaft distance is adjustable by the shaft-to-shaft distance adjusting unit depending on a number of folding processes performed on the paper which is folded by the pair of folding rollers.

5. The paper folding device according to claim 1,
wherein the folding roller is formed of a rubber member provided on a surface of a metal member that is a cylindrical core, and
wherein a hardness of layer of the rubber is from 60 to 100 degrees defined by the JIS-A hardness.

6. The paper folding device according to claim 1,
wherein the folding roller is formed of a rubber member provided on a surface of a metal member that is a cylindrical core, and
wherein a thickness of the rubber member is from 1 mm to 5 mm.

7. The paper folding device according to claim 1,
wherein at least one folding roller of the pair of folding rollers is formed of a cylindrical metal member.

8. The paper folding device according to claim 7,
wherein a coating process is performed in a manner such that a material, of which friction coefficient against paper is larger than that of a surface of the metal member, is coated on a surface of the cylindrical metal member so as to make a coating layer thereon.

9. The paper folding device according to claim 8,
wherein the coating process is performed by coating the surface of the metal member with a resin.
